(19) United States
(12) Patent Application Publication
(10) Pub. No.: US 2024/0104835 A1
(43) Pub. Date: Mar. 28, 2024

(54) INFORMATION PROCESSING APPARATUS, INFORMATION PROCESSING METHOD, AND NON-TRANSITORY COMPUTER READABLE MEDIUM

(71) Applicant: FUJIFILM Business Innovation Corp., Tokyo (JP)

(72) Inventors: Jungo HARIGAI, Kanagawa (JP); Miho UNO, Kanagawa (JP); Yoshitaka KUWADA, Kanagawa (JP)

(73) Assignee: FUJIFILM Business Innovation Corp., Tokyo (JP)

(21) Appl. No.: 18/325,161

(22) Filed: May 30, 2023

(30) Foreign Application Priority Data
Sep. 27, 2022 (JP) 2022-153971

(51) Int. Cl. G06T 15/50; G06T 3/00; G06T 7/514; G06T 7/73; G06T 15/20

(52) U.S. Cl. CPC G06T 15/506; G06T 3/0087; G06T 7/514; G06T 7/74; G06T 15/205

(57) ABSTRACT

An information processing apparatus includes a processor configured to: acquire a position of principal illumination from a spherical image; acquire a direction of a principal normal of an object to be observed; acquire an observation condition of the object; and identify, on a basis of the position of principal illumination, the direction of the principal normal, and the observation condition, a positional relationship with which a light component reflected specularly by a plane corresponding to the principal normal.

### CROSS-REFERENCE TO RELATED APPLICATIONS

This application is based on and claims priority under 35 USC 119 from Japanese Patent Application No. 2022-153971 filed Sep. 27, 2022.

### BACKGROUND

### (i) Technical Field

The present disclosure relates to an information processing apparatus, an information processing method, and a non-transitory computer readable medium.

### (ii) Related Art

Physically based rendering is a technology that uses a computer to reproduce the apparent color and gloss of an object. However, physically based rendering is computationally expensive, making real-time simulation difficult. Accordingly, a method is also used in which the computational cost associated with reproducing an illuminance distribution is reduced by pre-calculating an illuminance distribution for all normal directions of an object (see Japanese Unexamined Patent Application Publication No. 2005-122719, for example).

### SUMMARY

At present, cameras capable of capturing an image in all directions at once are being put to practical use. Cameras of this type are also referred to as spherical cameras, and an image captured with a spherical camera is referred to as a 360-degree panoramic image (hereinafter also referred to as a “spherical image”). A spherical image contains information (hereinafter also referred to as “luminance information”) about ambient light at the image capture location. Therefore, using a spherical image makes it possible to simulate the apparent color and gloss of an object at any location. Incidentally, the apparent gloss and color of an object changes depending on the positional relationships among the object, the light source, and the camera. For this reason, the gloss and color reproduced by simulation may not meet user expectations in some cases.

Aspects of non-limiting embodiments of the present disclosure relate to making control of the representation of an object approach the representation in an environment where the object is to be observed, as compared to the case in which positional relationships among the object, the light source, and the camera are not acquired. Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: acquire a position of principal illumination from a spherical image; acquire a direction of a principal normal of an object to be observed; acquire an observation condition of the object; and identify, on a basis of the position of principal illumination, the direction of the principal normal, and the observation condition, a positional relationship with which a light component reflected specularly by a plane corresponding to the principal normal.

### BRIEF DESCRIPTION OF THE DRAWINGS

Exemplary embodiments of the present disclosure will be described in detail based on the following figures, wherein:

FIG. 1 is a diagram illustrating an exemplary configuration of a printing system used in a first exemplary embodiment;

FIG. 2 is a diagram for explaining an exemplary hardware configuration of a print server;

FIG. 3 is a diagram illustrating an exemplary hardware configuration of a client terminal;

FIG. 4 is a diagram illustrating an exemplary functional configuration of the print server assumed in the first exemplary embodiment;

FIG. 5 is a diagram for explaining operations for acquiring illumination information, sample information, and camera information by an information acquisition unit;

FIG. 6 is a diagram illustrating an example of a sample;

FIG. 7 is a diagram illustrating an example of processing operations to acquire a principal normal vector of a sample;

FIG. 8 is a diagram illustrating an example of a glossiness settings screen displayed on a display of the client terminal;

FIG. 9 is a diagram for explaining a specific example of a specular position in a first control example;

FIG. 10 is a diagram for explaining an example of an image reproducing the appearance of a sample after controlling orientation;

FIG. 11 is a diagram illustrating another example of a glossiness settings screen displayed on a display of the client terminal;

FIG. 12 is a diagram for explaining a specific example of a specular position in a second control example;

FIG. 13 is a diagram illustrating another example of a glossiness settings screen displayed on a display of the client terminal;

FIG. 14 is a diagram for explaining a specific example of a specular position in a third control example;

FIG. 15 is a diagram illustrating another example of a glossiness settings screen displayed on a display of the client terminal;

FIG. 16 is a diagram for explaining a specific example of a specular position in a fourth control example;

FIG. 17 is a diagram for explaining a method of acquiring the position of principal illumination in a second exemplary embodiment;

FIG. 18 is a diagram illustrating another example of a glossiness settings screen displayed on a display of the client terminal;

FIG. 19 is a diagram for explaining an exemplary display of a sample image with an assist display;

FIG. 20 is a diagram illustrating an example of an image of a sample in which the glossiness has been increased according to a counterclockwise manipulation by a user;

FIG. 21 is a diagram illustrating an example of an image of a sample in which the glossiness has been decreased according to a clockwise manipulation by the user;

FIG. 22 is a diagram for explaining a change in the orientation of a sample image in a case in which an X axis defining the manipulation screen and an x axis of the sample displayed on the manipulation screen are orthogonal;

FIG. 23 is a flowchart for explaining a process of correcting a rotation axis with a processor;

FIG. 24 is a diagram for explaining a change in the orientation of a sample image in a case in which the X axis defining the manipulation screen and the x axis of the sample displayed on the manipulation screen are parallel;

FIG. 25 is a diagram for explaining a change in the orientation of a sample image in a case in which the X axis defining the manipulation screen and the x axis of the sample displayed on the manipulation screen are approximately 45° apart;

FIG. 26 is a diagram for explaining a change in the orientation of a sample image in a case in which the X axis defining the manipulation screen and the x axis of the sample displayed on the manipulation screen are approximately 90° apart;

FIG. 27 is a diagram illustrating an exemplary configuration of an information processing system used in a fifth exemplary embodiment; and

FIG. 28 is a diagram illustrating an example of processing operations to acquire a principal normal vector of a three-dimensional shape.

### DETAILED DESCRIPTION

### First Exemplary Embodiment

### <System Configuration>

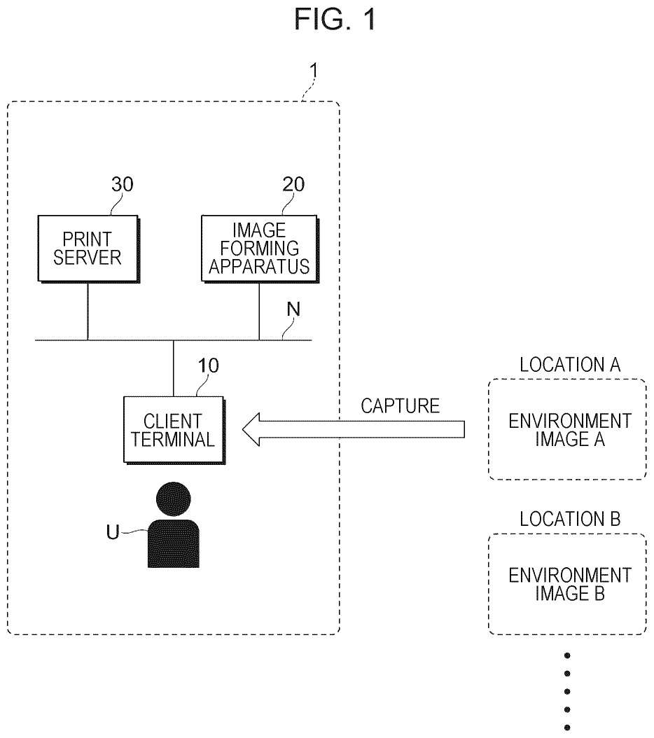

Hereinafter, exemplary embodiments of the present disclosure will be described with reference to the drawings. FIG. 1 is a diagram illustrating an exemplary configuration of a printing system 1 used in a first exemplary embodiment. The printing system 1 illustrated in FIG. 1 includes a client terminal 10, an image forming apparatus 20, and a print server 30. These terminals are communicably connected over a network N. Note that the client terminal 10, the image forming apparatus 20, and the print server 30 are all examples of an information processing apparatus.

A computer is assumed to be the basic configuration of the client terminal 10 and the print server 30. Note that the image forming apparatus 20 and the print server 30 may also be connected by a dedicated line. The image forming apparatus 20 is an apparatus that forms an image on a recording medium such as paper. Toner or ink is used as the recording material used to form an image. The colors of the recording material include the basic colors of Y (yellow), M (magenta), C (cyan), and K (black), in addition to metallic and fluorescent colors, which are referred to as special colors.

For the client terminal 10, a desktop computer, a laptop computer, a tablet computer, a smartphone, or a wearable computer is used, for example. In the case of the present exemplary embodiment, the client terminal 10 is used as an input-output device for the most part. The image forming apparatus 20 in the present exemplary embodiment may be a production printer, a printer used in an office, or a printer used at home, for example. The image forming apparatus 20 may be provided with scanner functions in addition to printer functions. Note that the printer functions may be for a printing method corresponding to an electrophotographic system or a printing method corresponding to an inkjet system.

In the print server 30 in the present exemplary embodiment, a function of accepting a print job from the client terminal 10 and outputting the print job to the image forming apparatus 20 and a function of reproducing the appearance of a good at an observation site are prepared. The “appearance” herein refers to the impression (also referred to as the texture) that the color and gloss of the good gives to people. Color and gloss are influenced by the uneven structure of the surface, the normal direction of the surface and the incident direction of illuminating light, the intensity of illuminating light, and the color of illuminating light.

The print server 30 in the present exemplary embodiment accepts from the client terminal 10 an image (hereinafter referred to as the “environment image”) of the observation site and information about the good of which the appearance is to be reproduced, and uses computer technology to reproduce the appearance of the good at an orientation designated by the user. The information about the good includes three-dimensional shape, fine surface structure, pattern, and color, for example.

The environment image is uploaded to the print server 30 from the client terminal 10, for example. Note that an environment image designated by the client terminal 10 may also be downloaded from a source such as the Internet or read from data storage by the print server 30. In FIG. 1, an environment image captured at a location A is referred to as the “environment image A”, and an environment image captured at a location B is referred to as the “environment image B”.

The environment image in the present exemplary embodiment includes spherical images and upper hemispherical images, for example. An upper hemispherical image refers to the upper half above the equator of a spherical image. However, an upper hemispherical image does not have to be an image strictly captured from the equator to the zenith, and may also be an image captured from a certain latitude to the zenith. In the present exemplary embodiment, spherical images and upper hemispherical images are collectively referred to as “spherical images”.

The observation site is the place where the good is expected to be observed, and is assumed to be a specific booth in an exhibition hall, an exhibition room, or a conference room, for example. A booth is a space marked off by a partition or the like. However, the observation site is not limited to an indoor environment and may also be an outdoor environment. If the intensity and color of illuminating light are different, the observed texture may be different, even if the good is the same. Moreover, if the incident direction of illuminating light and the normal direction of the surface of the good are different, the observed texture may be different, even if the intensity and color of illuminating light are the same.

The network N in FIG. 1 is assumed to be a local area network (LAN). The network N may be a wired network or a wireless network. For a wired network, Ethernet® is used, for example. For a wireless network, Wi-Fi® is used, for example. Note that one of each of the client terminal 10, the image forming apparatus 20, and the print server 30 is connected to the network N of the printing system 1 illustrated in FIG. 1, but more than one of each may also be connected.

<Terminal Configuration>

### <Hardware Configuration of Print Server>

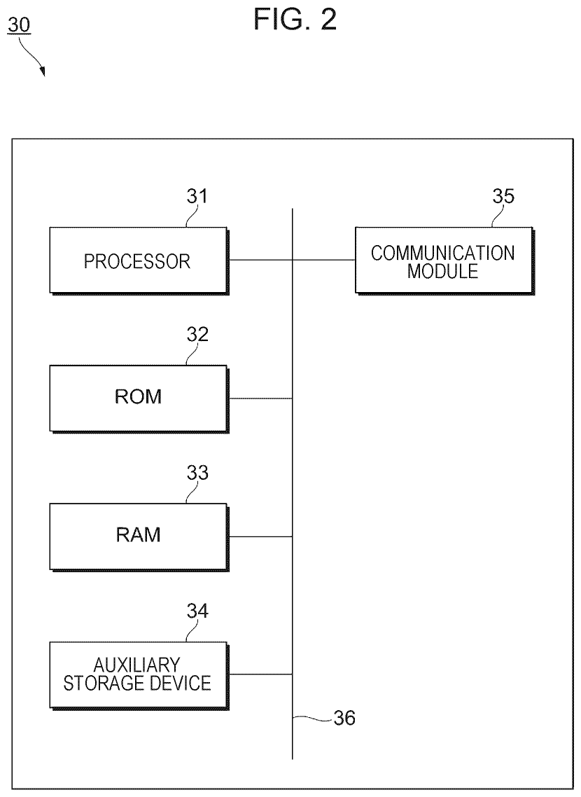

FIG. 2 is a diagram for explaining an exemplary hardware configuration of the print server 30. The print server 30 illustrated in FIG. 2 includes a processor 31, read-only memory (ROM) 32 storing data such as a basic input-output system (BIOS), random access memory (RAM) 33 that is used as a work area of the processor 31, an auxiliary storage device 34, and a communication module 35. Each device is connected through a bus or other signal line 36.

The processor 31, ROM 32, and RAM 33 function as what is called a computer. The processor 31 achieves various functions through the execution of a program. For example, the processor 31 acquires information related to illumination (hereinafter referred to as “illumination information”) from an environment image and generates an image reproducing the appearance of a good at the observation site. In the present exemplary embodiment, the generation of an image reproducing the appearance of a good is referred to as “controlling the representation of an image”.

The auxiliary storage device 34 includes a hard disk drive and/or semiconductor storage, for example. A program and various data are stored in the auxiliary storage device 34. Here, “program” is used as a collective term for an operating system (OS) and application programs. One of the application programs is a program that simulates the texture of a good. In the case of FIG. 2, the auxiliary storage device 34 is built into the print server 30, but the auxiliary storage device 34 may also be externally attached to the print server 30 or reside on the network N (see FIG. 1).

The communication module 35 is an interface that achieves communication with the client terminal 10 (see FIG. 1) and the image forming apparatus 20 over the network N. In the communication module 35, a module conforming to Ethernet®, Wi-Fi®, or any other communication standard is used.

<Hardware Configuration of Client Terminal>

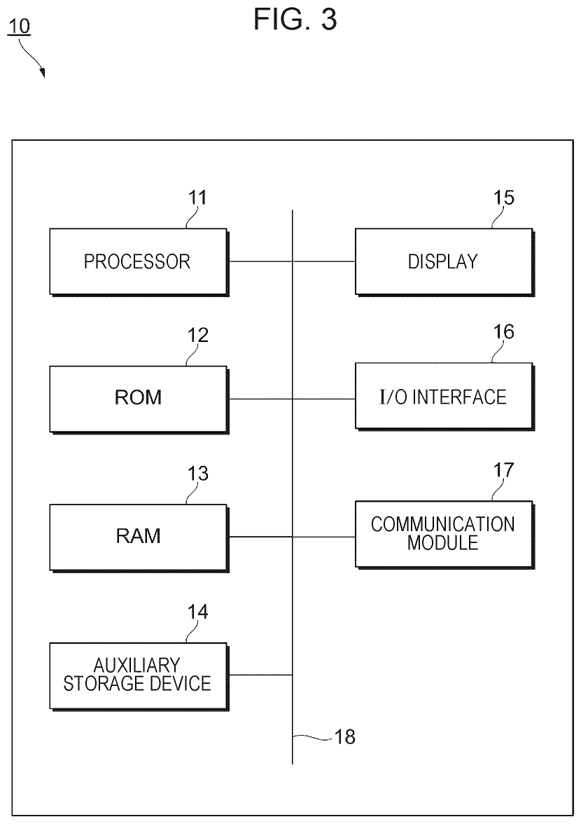

FIG. 3 is a diagram illustrating an exemplary hardware configuration of the client terminal 10. The client terminal 10 illustrated in FIG. 3 includes a processor 11 that controls the operations of the apparatus as a whole, ROM 12 storing a BIOS and the like, RAM 13 used as a work area of the processor 11, an auxiliary storage device 14, a display 15, an input-output (I/O) interface 16, and a communication module 17. Note that the processor 11 and other devices are connected through a bus or other signal line 18.

The processor 11, ROM 12, and RAM 13 function as what is called a computer. The processor 11 achieves various functions through the execution of a program. For example, the processor 11 executes the uploading of an environment image, the uploading of information on a good to be observed at an observation site, and the displaying of an image reproducing the appearance of the good. The auxiliary storage device 14 is a hard disk drive and/or semiconductor storage, for example. Besides an OS and other programs, an environment image, an image of a good to be processed, and the like are stored in the auxiliary storage device 14. The display 15 is a liquid crystal display (LCD) or an organic light-emitting diode (OLED) display, for example. An image reproducing the appearance of a good at an observation site is displayed on the display 15.

The I/O interface 16 is a device that accepts inputs from a user using a keyboard and mouse, for example. Specifically, the I/O interface 16 accepts inputs such as positioning and moving a mouse cursor, and clicking. The I/O interface 16 is also a device that outputs data to an externally attached display, storage device, or the like. The communication module 17 is a device enabling communication with the print server 30 and the like connected to the network N. In the communication module 17, a module conforming to Ethernet®, Wi-Fi®, or any other communication standard is used.

<Overview of Processing Operations>

Hereinafter, a process which is to be executed by the print server 30 (see FIG. 1) and which is for reproducing the appearance of an object will be described. Processing operations in the present exemplary embodiment are initiated by supplying information on a good and an environment image from the client terminal 10 (see FIG. 1) to the print server 30.

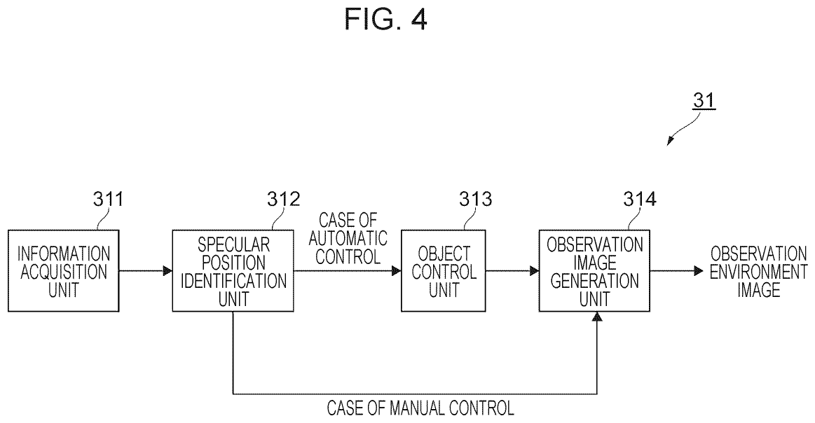

FIG. 4 is a diagram illustrating an exemplary functional configuration of the print server 30 assumed in the first exemplary embodiment. In FIG. 4, portions that correspond to FIG. 2 are denoted with the same signs. Through the execution of a program, the processor 31 functions as an information acquisition unit 311, a specular position identification unit 312, an object control unit 313, and an observation image generation unit 314.

The information acquisition unit 311 is a functional unit that acquires illumination information, sample information, and camera information. The information acquisition unit 311 acquires the above information through uploading from the client terminal 10, for example. However, the information acquisition unit 311 may also acquire the illumination information, sample information, and camera information from the auxiliary storage device 34 (see FIG. 2) through an instruction from the client terminal 10.

In the case of the present exemplary embodiment, the illumination information gives the illumination environment of the observation site, and is acquired through analysis of the luminance distribution of a spherical image. The illumination information is an example of the “position of principal illumination”. In the present exemplary embodiment, the position of principal illumination is identified as the region of highest luminance in a spherical image. Note that the illumination information is defined in the coordinate space of the observation site.

In the case of the present exemplary embodiment, the sample information gives the position of a sample at the observation site, the orientation of the sample, and the principal normal direction of the sample. The sample information is defined in the coordinate space of the observation site. However, the sample information may also contain the reflection characteristics of the sample surface, the color of the sample surface, the roughness of the sample surface, and the quality of the sample. The initial position of the sample is given as the center point of the spherical image. The sample is an example of an “object to be observed”.

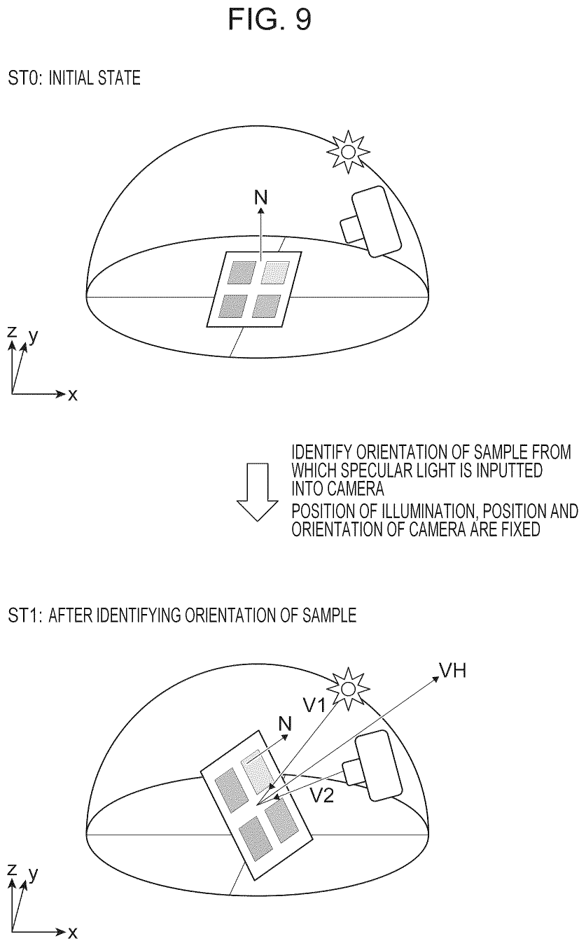

In the case of present exemplary embodiment, the camera information gives the position and the line-of-sight direction of the camera with which to observe the sample. Here, the line-of-sight direction is given as a line-of-sight vector V2 (see FIG. 9) described later. In the following, the “line-of-sight direction” is also referred to as the “orientation of the camera”. The camera information is defined in the coordinate space of the observation site. In the case of the present exemplary embodiment, the distance between the camera and the sample is assumed to be a fixed length. The camera information is an example of an “observation condition”. Note that the camera in the present exemplary embodiment gives the position of a viewpoint and the direction of a line of sight for calculating an image reproducing the appearance of the sample at the observation site. The camera herein exists as data, and is not an actual camera.

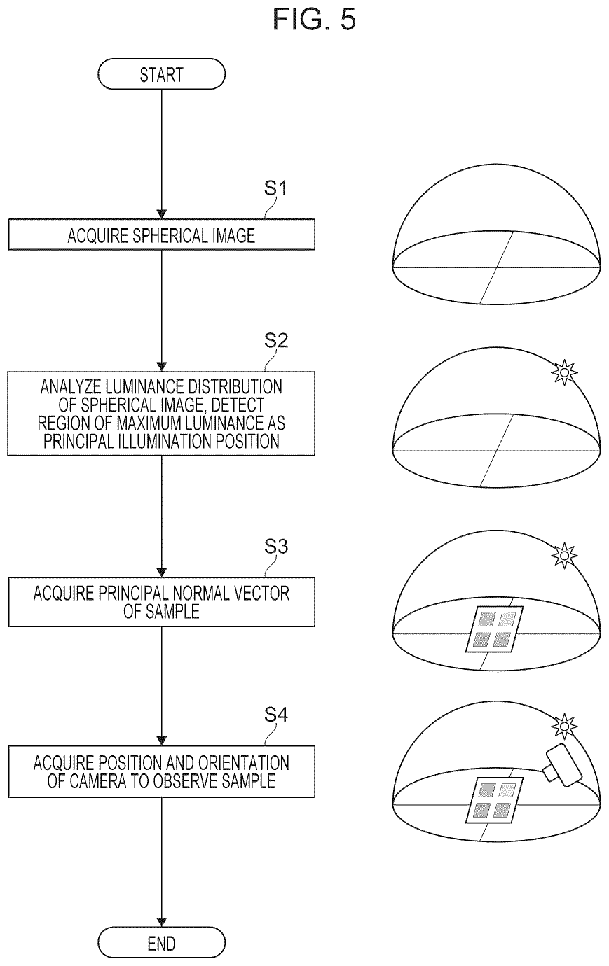

FIG. 5 is a diagram for explaining operations for acquiring the illumination information, the sample information, and the camera information by the information acquisition unit 311 (see FIG. 4). Note that the symbol “S” in the diagram means “step”. First, the processor 31 acquires a spherical image (step 1). In FIG. 5, the spherical image is expressed as an upper hemispherical image. The image format of the spherical image is assumed to be the HDR (High Dynamic Range) format or the OpenEXR format, for example. The HDR format and the OpenEXR format are known as high dynamic range file formats. The OpenEXR format has higher tonal precision than the HDR format. In other words, the OpenEXR format is capable of expressing finer gradations than the HDR format. In the HDR format, RGB and an exponent are represented using 8 bits each (that is, 32 bits in total) for a single pixel.

In the OpenEXR format, for a single pixel, RGB is represented using 16 bits each, a sign is represented using 1 bit, an exponent is represented using 5 bits, and a significand is represented using 10 bits. Note that versions in which RGB is represented using 32 bits each and 24 bits each also exist.

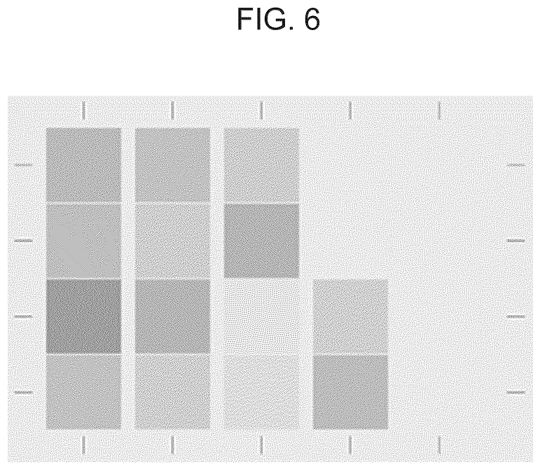

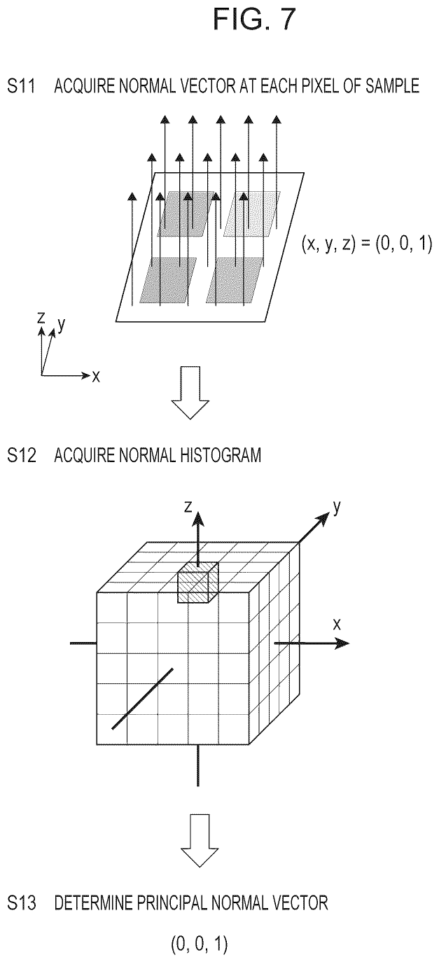

Next, the processor 31 analyzes the luminance distribution of the spherical image and detects the region where the maximum luminance appears as the principal illumination position (step 2). Next, the processor 31 acquires the principal normal vector of the sample (step 3). In the case of the present exemplary embodiment, the sample is placed at the origin of the spherical image. FIG. 6 is a diagram illustrating an example of a sample. In FIG. 6, a color chart is illustrated as an example of the sample. A color chart is a collection of multiple color swatches. FIG. 7 is a diagram illustrating an example of processing operations to acquire a principal normal vector N of a sample.

First, the processor 31 acquires the normal vector N at each pixel of the sample (step 11). Next, the processor 31 acquires a normal histogram, which is a distribution of the acquired normal vectors (step 12). Next, the processor 31 determines the normal occurring most frequently in the normal histogram as the “principal normal vector” (step 13). In the case of the present exemplary embodiment, the sample is a two-dimensional color chart, and therefore the principal normal vector is (x, y, z)=(0, 0, 1).

The description will now return to FIG. 5. Next, the processor 31 acquires the position and orientation of the camera with which to observe the sample (step 4). The orientation herein is the direction of the optical axis of the camera. In other words, the orientation is the direction of the line of sight in which the sample is to be observed. In the case of the present exemplary embodiment, the initial position of the camera is predetermined, and the position and orientation of the camera is defined as a direction in which to observe the plane on which the principal normal vector of the sample appears.

The specular position identification unit 312 (see FIG. 4) is a functional unit that identifies, on the basis of user settings, a positional relationship with which the light component reflected specularly by the plane corresponding to the principal normal vector of the sample is observed by the camera. Note that the user settings are specified on a glossiness settings screen.

<First Control Example>

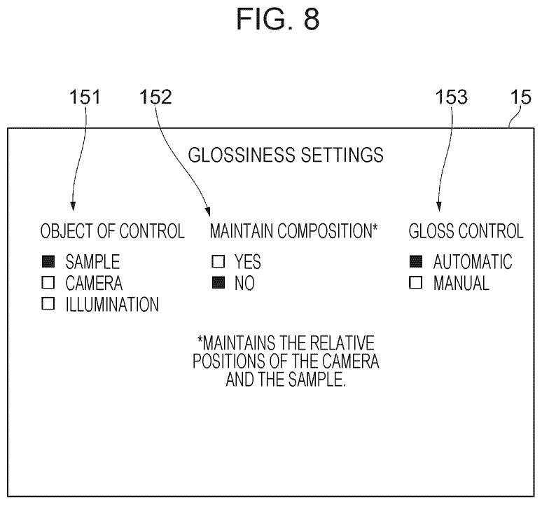

FIG. 8 is a diagram illustrating an example of a glossiness settings screen displayed on the display 15 of the client terminal 10. On the settings screen illustrated in FIG. 8, an object of control designation field 151, a maintain composition designation field 152, and a gloss control designation field 153 are arranged. Note that in FIG. 8, a filled-in black checkbox represents the state of being selected by the user.

In the case of FIG. 8, “sample” is designated as the object of control in the object of control designation field 151. In other words, “camera” and “illumination” are designated as not under control. That is, the positions and the like of “camera” and “illumination” are to remain in the initial state. In the case of FIG. 8, “no” is designated in the maintain composition designation field 152. This means that the relative positions of the camera and the sample are not to be maintained. Note that if “sample” is selected as the object of control, “no” may designated automatically and displayed, or the maintain composition designation field 152 may be set to not be displayed.

In the case of FIG. 8, “automatic” is designated in the gloss control designation field 153. As described later, it is also possible to designate “manual” in the gloss control designation field 153. On the settings screen illustrated in FIG. 8, the user has designated that the orientation of the sample is to be controlled automatically so that the light component reflected specularly by the plane corresponding to the principal normal vector of the sample is observed by the camera.

FIG. 9 is a diagram for explaining a specific example of a specular position in the first control example. In the case of FIG. 9, the sample in an initial state ST0 is positioned at the center of the spherical image, with the principal normal vector N thereof parallel to the Z axis. In the case of FIG. 9, the position of principal illumination is indicated by the sun symbol, and the position and orientation of the camera are indicated by the camera symbol.

In FIG. 9, the direction of illuminating light incident on the plane corresponding to the principal normal vector N of the sample is represented by an illumination vector V1, and the direction of the optical axis of the camera capturing the plane corresponding to the principal normal vector N of the sample is represented by a line-of-sight vector V2. In addition, the vector midway between the illumination vector V1 and the line-of-sight vector V2 is represented by a half-vector VH. In this case, when the direction of the half-vector VH and the principal normal vector N of the sample are aligned, illuminating light reflected specularly by the surface of the sample is incident on the camera. Therefore, the specular position identification unit 312 (see FIG. 4) identifies the direction of the half-vector VH defined by the illumination vector V1 and the line-of-sight vector V2 as the positional relationship to be satisfied by the principal normal vector N of the sample.

In this control example, the object control unit 313 (see FIG. 4) controls the orientation of the sample to satisfy the positional relationship identified by the specular position identification unit 312. Specifically, the object control unit 313 controls the orientation of the sample that is the object of control so that, for example, the normalized normal vector N of the sample and the normalized half-vector VH have an inner product of “1”. The observation image generation unit 314 (see FIG. 4) generates an image to be observed (hereinafter referred to as the “observation image”) with respect to the sample after the orientation thereof is controlled. The generated observation image is displayed on the display 15 (see FIG. 3) of the client terminal 10 (see FIG. 1), for example.

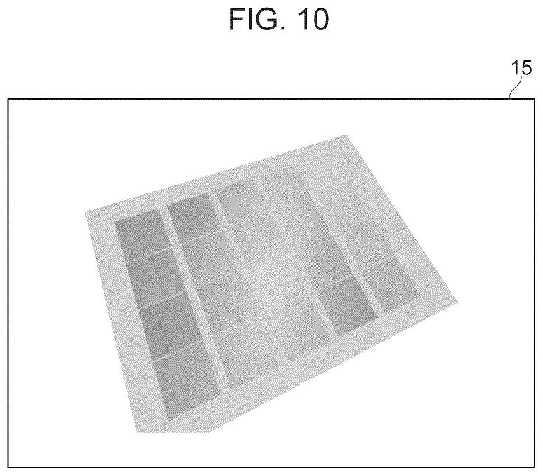

FIG. 10 is a diagram for explaining an example of an image reproducing the appearance of the sample after controlling orientation. The image illustrated in FIG. 10 is displayed on the display 15 of the client terminal 10. On the color chart illustrated in FIG. 10, glossiness is strongly apparent near the center. Note that the output destination of the image generated by the observation image generation unit 314 is not limited to the client terminal 10 that uploaded the environment image, and may also be another client terminal 10 or the auxiliary storage device 34 (see FIG. 2) in the print server 30. Moreover, the output destination of the image generated by the observation image generation unit 314 may be another server that cooperates with the print server 30. This arrangement allows the glossiness of the sample to approach the appearance at the observation site, assuming the positional relationship between the camera and the illumination at the observation site.

<Second Control Example>

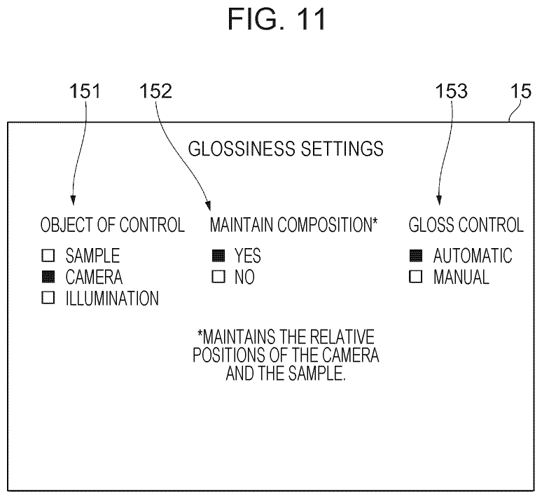

Next, a second control example will be described. In the first control example described above, an example of designating the sample as the object of control is described, but in the second control example, the camera is the object of control. FIG. 11 is a diagram illustrating another example of the glossiness settings screen displayed on the display 15 of the client terminal 10. In FIG. 11, portions that correspond to FIG. 8 are denoted with the same signs.

In the case of FIG. 11, “camera” is designated as the object of control in the object of control designation field 151. In other words, “sample” and “illumination” are designated as not under control. That is, the positions and the like of “sample” and “illumination” are to remain at the initial positions. The other settings are the same as in the first control example. That is, the gloss control is designated automatic and the composition is designated as not to be maintained.

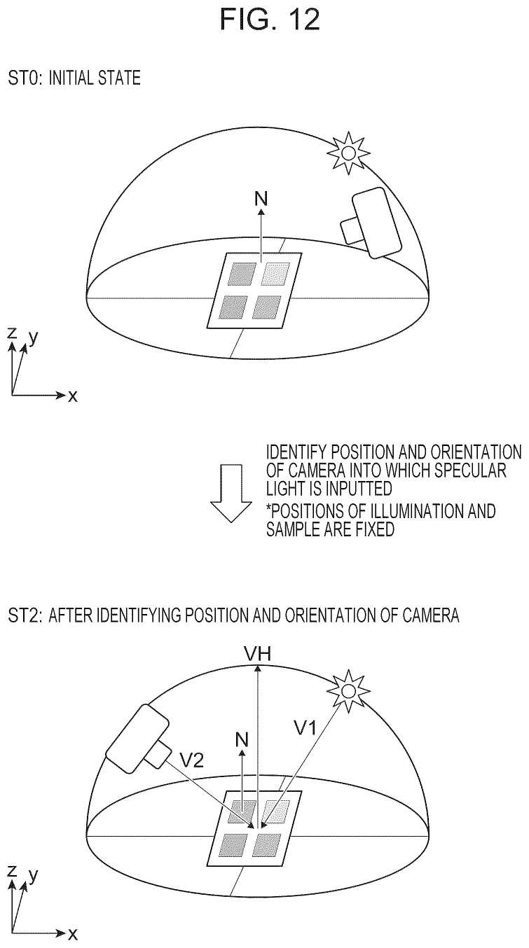

FIG. 12 is a diagram for explaining a specific example of the specular position in the second control example. In FIG. 12, portions that correspond to FIG. 9 are denoted with the same signs. The initial state ST0 in FIG. 12 is the same as the initial state in FIG. 9. Likewise in FIG. 12, when the direction of the half-vector VH and the principal normal vector N of the sample are aligned, illuminating light reflected specularly by the surface of the sample is incident on the camera. Therefore, the specular position identification unit 312 (see FIG. 4) identifies the direction of the principal normal vector N of the sample as the positional relationship to be satisfied by the half-vector VH defined by the illumination vector V1 and the line-of-sight vector V2.

In this control example, the object control unit 313 (see FIG. 4) controls the position and orientation of the camera to satisfy the positional relationship identified by the specular position identification unit 312. Specifically, the object control unit 313 controls the position and orientation of the camera that is the object of control so that, for example, the normalized normal vector N of the sample and the normalized half-vector VH have an inner product of “1”. The observation image generation unit 314 (see FIG. 4) generates an observation image to be observed by the camera after the position and orientation thereof are controlled. The generated observation image is displayed on the display 15 (see FIG. 3) of the client terminal 10 (see FIG. 1), for example. This arrangement allows the glossiness of the sample to approach the appearance at the observation site, assuming the positional relationship between the sample and the illumination at the observation site.

<Third Control Example>

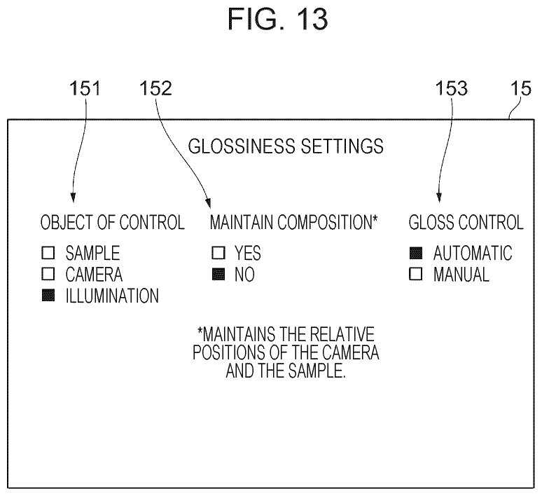

Next, a third control example will be described. In the first control example described above, an example of designating the sample as the object of control is described, but in the third control example, the illumination is the object of control. FIG. 13 is a diagram illustrating another example of the glossiness settings screen displayed on the display 15 of the client terminal 10. In FIG. 13, portions that correspond to FIG. 8 are denoted with the same signs.

In the case of FIG. 13, “illumination” is designated as the object of control in the object of control designation field 151. In other words, “sample” and “camera” are designated as not under control. That is, the positions and the like of “sample” and “camera” are to remain at the initial positions. This state is also the case in which the composition of the sample to be captured by the camera is designated. The other settings are the same as in the first control example. That is, the gloss control is designated automatic and the composition is designated as not to be maintained.

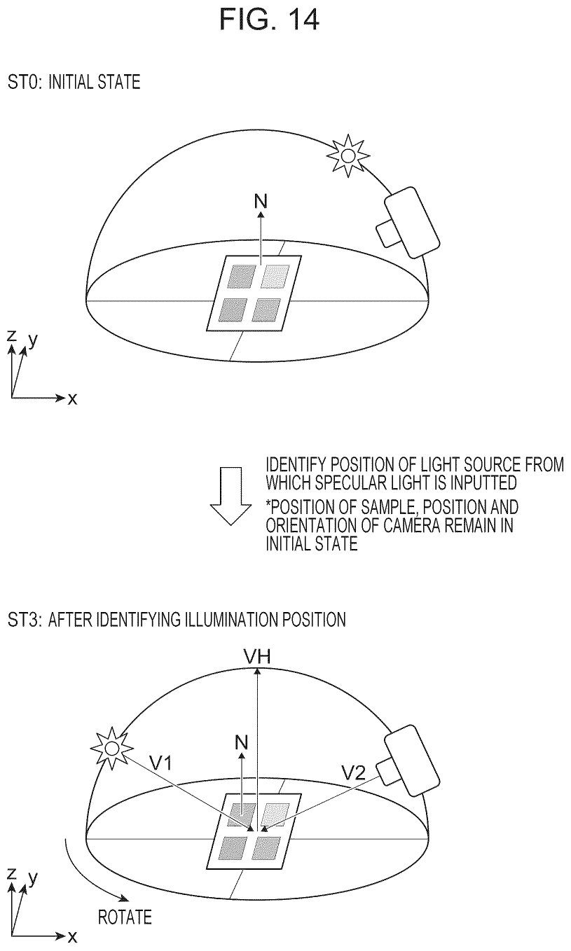

FIG. 14 is a diagram for explaining a specific example of the specular position in the third control example. In FIG. 14, portions that correspond to FIG. 9 are denoted with the same signs. The initial state ST0 in FIG. 14 is the same as the initial state in FIG. 9. Likewise in FIG. 14, when the direction of the half-vector VH and the principal normal vector N of the sample are aligned, illuminating light reflected specularly by the surface of the sample is incident on the camera. Therefore, the specular position identification unit 312 (see FIG. 4) identifies the direction of the principal normal vector N of the sample as the positional relationship to be satisfied by the half-vector VH defined by the illumination vector V1 and the line-of-sight vector V2.

In this control example, the object control unit 313 (see FIG. 4) controls the position of the illumination to satisfy the positional relationship identified by the specular position identification unit 312. Specifically, the object control unit 313 controls the position of the illumination that is the object of control so that, for example, the normalized normal vector N of the sample and the normalized half-vector VH have an inner product of “1”. In FIG. 14, the spherical image is rotated about an axis passing through the center and the zenith of the spherical image. Specifically, the longitude of the illumination is moved to the position of the camera longitude+180°.

Note that in the case of FIG. 14, if the illumination and the camera are on different latitudes in the initial state ST0, the half-vector VH will not be parallel to the principal normal vector N of the sample. For this reason, the position of the illumination may be moved so that the illumination is on the same latitude as the camera. In this case, the half-vector VH will be parallel to the principal normal vector N of the sample. The observation image generation unit 314 (see FIG. 4) generates an observation image of the sample to be observed by the camera under the illumination after the position thereof is controlled. The generated observation image is displayed on the display 15 (see FIG. 3) of the client terminal 10 (see FIG. 1), for example. This arrangement allows the glossiness of the sample to approach the appearance at the observation site, assuming the positional relationship between the sample and the camera at the observation site.

<Fourth Control Example>

Next, a fourth control example will be described. In the first to third control examples described above, only one from among the sample, the camera, and the illumination is the object of control. Consequently, the position of the camera to capture the sample also changes in some situations. Moreover, even if the positional relationship between the sample and the camera is fixed, the position of the illumination changes greatly in some situations. Accordingly, the fourth control example describes a case in which the position of the light source is fixed, and the sample and the camera are controlled in a unitary manner with respect to the light source. That is, the following describes the case of controlling the positions and the like of the sample and the camera to maximize glossiness while keeping the composition fixed.

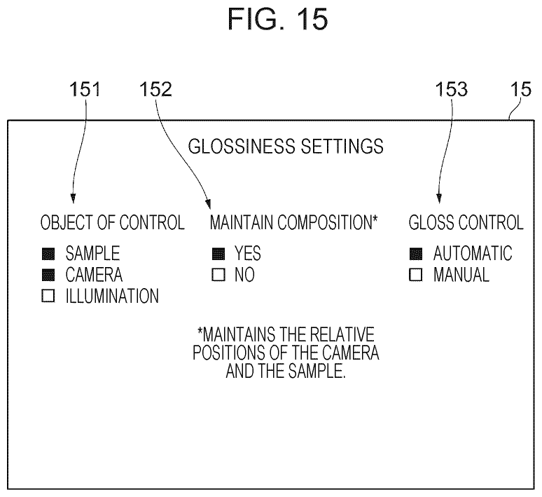

FIG. 15 is a diagram illustrating another example of the glossiness settings screen displayed on the display 15 of the client terminal 10. In FIG. 15, portions that correspond to FIG. 8 are denoted with the same signs. In the case of FIG. 15, “yes” is designated in the maintain composition designation field 152. Therefore, the relative positions of the camera and the sample are to be maintained.

Additionally, as a result of “yes” being designated in the maintain composition designation field 152, both the sample and the camera are designated as the object of control in the object of control designation field 151. However, the designation in the object of control designation field 151 may also be canceled when “yes” is designated in the maintain composition designation field 152. The maintain composition designation field 152 may also be switched to “yes” automatically if the sample and the camera are designated in the object of control designation field 151. The other settings are the same as in the first control example. In other words, automatic gloss control is designated.

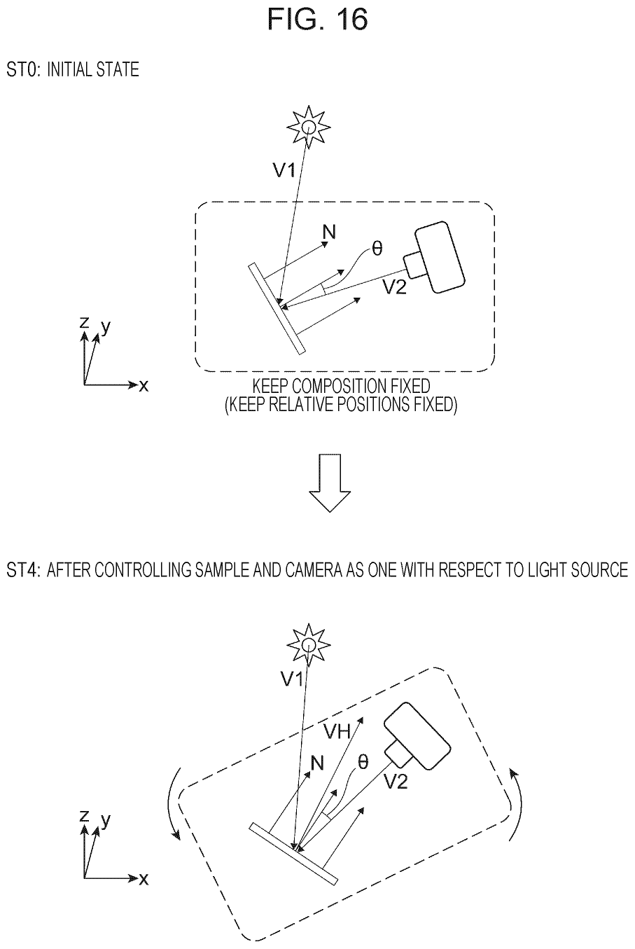

FIG. 16 is a diagram for explaining a specific example of the specular position in the fourth control example. In FIG. 16, portions that correspond to FIG. 9 are denoted with the same signs. The initial state ST0 in FIG. 16 represents a case in which the sample is not parallel to the plane defined by the x and y axes, that is, the case in which the principal normal vector N is inclined with respect to the z axis. This state also represents a case in which the angle obtained between the normal vector N of the sample and the line-of-sight vector V2 of the camera is 0. In the fourth control example, the sample and the camera are moved in a unitary manner while keeping the angle obtained between the normal vector N of the sample and the line-of-sight vector V2 of the camera at θ. In FIG. 16, the relationship in which the sample and the camera are moved in a unitary manner is indicated by the dashed-line enclosing frame.

Likewise in FIG. 16, when the direction of the half-vector VH and the principal normal vector N of the sample are aligned, illuminating light reflected specularly by the surface of the sample is incident on the camera. Accordingly, the specular position identification unit 312 (see FIG. 4) in the fourth control example searches for a positional relationship in which the direction of the principal normal vector N of the sample and the direction of the half-vector VH defined by the illumination vector V1 and the line-of-sight vector V2 are aligned. The positions and orientations of the sample and the camera that are the objects of control are controlled in a unitary manner so that, for example, the normalized normal vector N of the sample and the normalized half-vector VH have an inner product of “1”.

The state ST4 in FIG. 16 represents the relationship between the positions and orientations of the camera and the sample in which the normal vector N of the sample and the half-vector VH, which is defined by the illumination vector V1 and the line-of-sight vector V2, are parallel. The positions and orientations of the sample and the camera in the state ST4 have been changed in a unitary manner from the positions in the initial state ST0.

In this control example, the object control unit 313 (see FIG. 4) controls the sample and the camera in a unitary manner with respect to the light source to satisfy the positional relationship identified by the specular position identification unit 312. The observation image generation unit 314 (see FIG. 4) generates an observation image to be observed by the camera of which the position and orientation have been controlled in a unitary manner with the sample with respect to the light source. The generated observation image is displayed on the display 15 (see FIG. 3) of the client terminal 10 (see FIG. 1), for example. This arrangement allows the glossiness of the sample to approach the appearance at the observation site, assuming the composition designated by the user.

<Conclusion>

According to the present exemplary embodiment, by simply providing a spherical image captured at the observation site, it is possible to generate an image of the sample reproducing the glossiness in the illumination environment at the observation site. At this time, the print server 30 automatically generates an image of the sample in which the observed glossiness is maximized.

### Second Exemplary Embodiment

The exemplary embodiment above describes the case of analyzing a luminance distribution of the environment image and detecting the region where the maximum luminance appears as the principal illumination position, but if multiple light sources or a light source with a broad illumination range exists at the observation site, uniquely identifying the illumination position is difficult or the precision of identifying the illumination position is lowered. Accordingly, the present exemplary embodiment describes a case in which a distribution of illuminance is obtained from the environment image and analyzed to acquire the position of principal illumination.

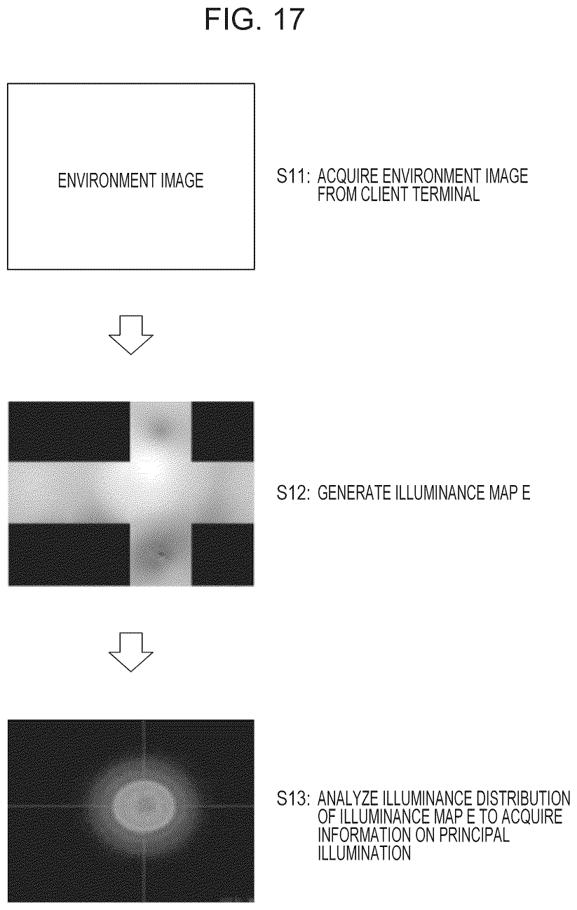

FIG. 17 is a diagram for explaining a method of acquiring the position of principal illumination in a second exemplary embodiment. First, the information acquisition unit 311 (see FIG. 4) acquires an environment image from the client terminal 10 (see FIG. 1) (step 11).

Next, the information acquisition unit 311 generates an illuminance map E from the environment image (step 12). The illuminance map E is a map expressing the distribution of illuminance on the surface of an object appearing in the environment image. The illuminance distribution represents a distribution of brightness per unit area. Note that it is possible to create the illuminance map E according to a known generation method. For example, the information acquisition unit 311 generates an environment map in which a spherical image is stretched over the surface of a virtual cube, and generates the illuminance map E from the created environment map.

Next, the information acquisition unit 311 analyzes the illuminance distribution in the illuminance map E to acquire information on the principal illumination (step 13). In the present exemplary embodiment, the principal illumination is defined to be the position where the mean illuminance value within a unit area is at a maximum. Otherwise, the principal illumination may be identified on the basis of a maximum value, percentile value, luminance variance, or other value of the illuminance within a unit area, for example. In the present exemplary embodiment, the position where the mean illuminance value appears is obtained as the position of principal illumination to minimize the effects of noise. The information acquisition unit 311 may also estimates the color and intensity of the principal illumination as information on the principal illumination. However, it is also possible to estimate color only or estimate intensity only. Note that the information on the principal illumination is not limited to the color and intensity of illuminating light.

In the present exemplary embodiment, the information on the principal illumination identified by the method described above is used in combination with the first exemplary embodiment. This arrangement makes it possible to identify with high precision the position of principal illumination, even if multiple light sources or a light source with a broad illumination range is included in the environment image. As a result, the print server 30 is capable of automatically generating an image of the sample in which the observed glossiness is maximized. Note that, rather than being used alone, the method of identifying the position of principal illumination using an illuminance distribution in the present exemplary embodiment may also be combined with the method of identifying the position of principal illumination using a luminance distribution. For example, the method of identifying the position of principal illumination using an illuminance distribution may be executed if the position of principal illumination is not identified from a luminance distribution or if the area of the position of principal illumination exceeds a threshold value, for example.

### Third Exemplary Embodiment

The exemplary embodiments above describe an example of automatically generating, under control by the print server 30, an image of the sample in which the glossiness is maximized in the illumination environment at the observation site, but it is also conceivable that the user may want to check changes to the glossiness manually in some cases. Accordingly, the present exemplary embodiment describes a function for assisting the user with manipulating the orientation of the sample under the assumption that the user changes the orientation of the sample manually.

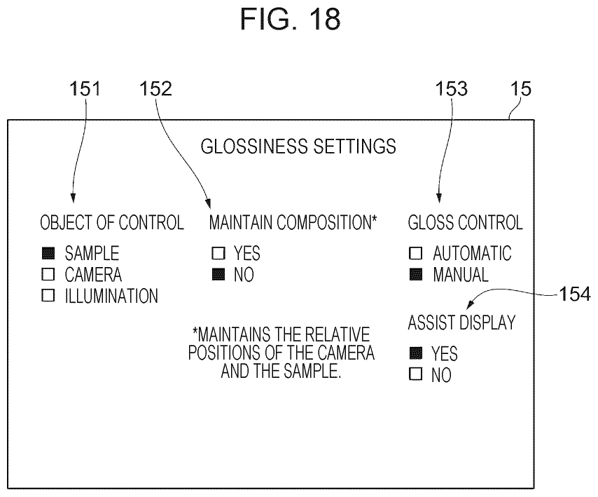

FIG. 18 is a diagram illustrating another example of the glossiness settings screen displayed on the display 15 of the client terminal 10. In the case of FIG. 18, “sample” is designated as the object of control in the object of control designation field 151, maintaining the composition is designated “no” in the maintain composition designation field 152, and “manual” is designated in the gloss control designation field 153. Note that on the settings screen illustrated in FIG. 18, an assist display designation field 154 is displayed as a result of manual gloss control being designated. In FIG. 18, the assist display is “yes”.

If the assist display for gloss control is “yes”, manipulation directions for increasing and decreasing glossiness are indicated on the screen with illustrations, arrows, and the like. On the other hand, if the assist display for gloss control is “no”, these illustrations, arrows, and the like are not displayed on the screen. Incidentally, the assist display designation field 154 may also be displayed on the screen in the case in which “automatic” is designated in the gloss control designation field 153. However, in this case, the assist display designation field 154 may be displayed in a manner that does not accept user input, such as by being grayed out.

Otherwise, on the settings screen illustrated in FIG. 18, the camera or the illumination may be set as the object of control instead of the sample in the object of control designation field 151. For example, if the camera is designated as the object of control, the relative positions and orientations of the sample and the camera are to be changed in conjunction with manual manipulations by the user. As a result, the glossiness of the sample changes in the image to be generated. Also, if the illumination is designated as the object of control, the relative positions of the sample and the illumination are to be changed in conjunction with manual manipulations by the user. As a result, the glossiness of the sample changes in the image to be generated.

Moreover, on the settings screen illustrated in FIG. 18, maintaining the composition may be designated “yes” in the maintain composition designation field 152. In this case, the relative positional relationship between the sample and the camera is maintained while changing the relative positions thereof with respect to the illumination in conjunction with manual manipulations by the user. As a result, the glossiness of the sample changes in the image to be generated. Incidentally, although the assist display is assumed to be illustrations, arrows, and the like in the present exemplary embodiment, the content of speech or types of sounds may also be used to notify the user of the relationship between the directions of manipulation and an increase or decrease in glossiness.

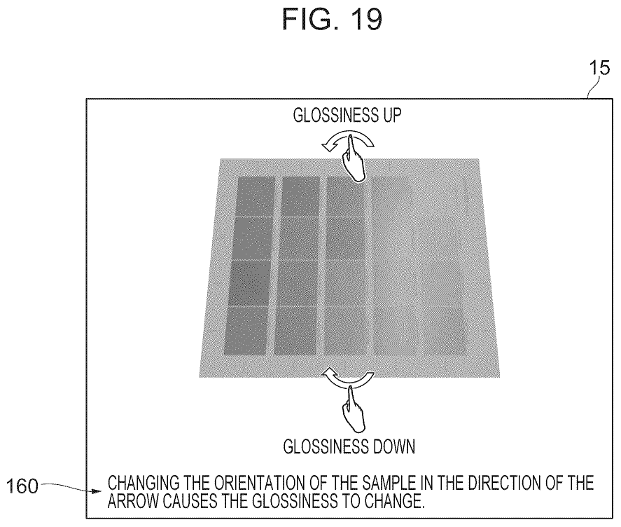

FIG. 19 is a diagram for explaining an exemplary display of a sample image with an assist display. The image illustrated in FIG. 19 is displayed on the display 15 of the client terminal 10. The sample image illustrated in FIG. 19 represents the appearance of the sample in the initial state. Consequently, the sample image has a composition in which the sample is captured from the front side. In the case of FIG. 19, an illustration and arrow indicating the direction of manipulation for increasing glossiness (glossiness up) is displayed at the top edge of the sample, and an illustration and arrow indicating the direction of manipulation for decreasing glossiness (glossiness down) is displayed at the bottom edge of the sample.

The assist display in FIG. 19 indicates that rotating the sample counterclockwise causes the glossiness to increase and rotating the sample clockwise causes the glossiness to decrease. In addition, on the screen illustrated in FIG. 19, an explanation 160 explaining the meaning of the illustrations and arrows is also displayed. Here, the message “Changing the orientation of the sample in the direction of the arrow causes the glossiness to change.” supplements explanation of the illustrations and arrows on the screen.

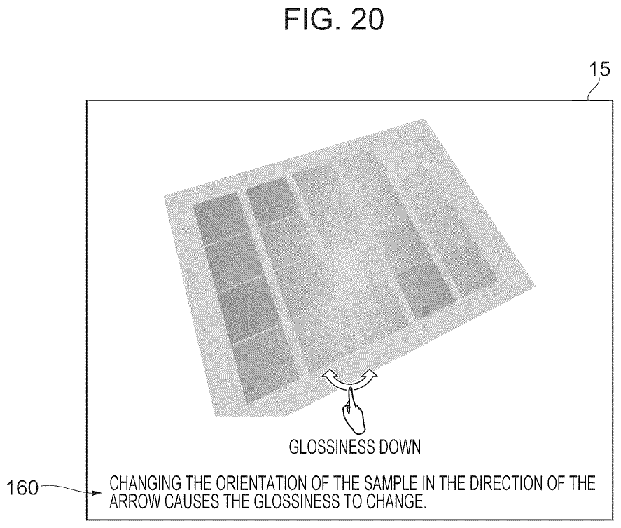

FIG. 20 is a diagram illustrating an example of an image of the sample in which the glossiness has been increased according to a counterclockwise manipulation by the user. In the sample image illustrated in FIG. 20, the glossiness near the center has increased and each color patch is brighter compared to the state before manipulation (the sample image illustrated in FIG. 19). The glossiness of the sample image illustrated in FIG. 20 is at maximum. For this reason, an illustration and arrow indicating that not only counterclockwise rotation but also clockwise rotation causes the glossiness to decrease is superimposed onto the sample image. However, too much counterclockwise rotation will cause the direction of increasing glossiness and the direction of decreasing glossiness to reverse. That is, the direction of increasing glossiness will be clockwise and the direction of decreasing glossiness will be counterclockwise.

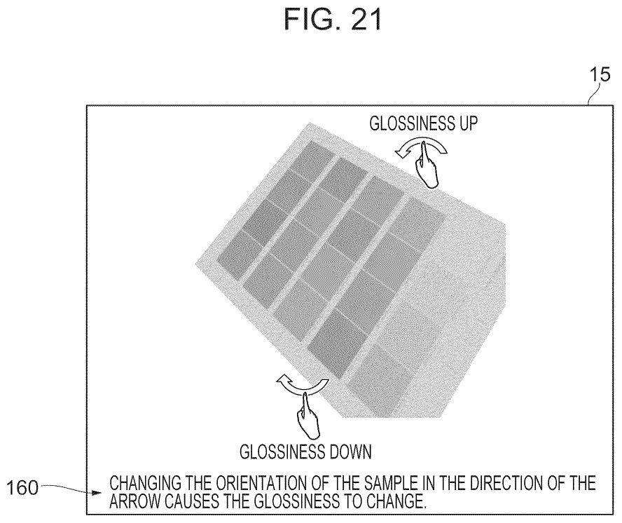

FIG. 21 is a diagram illustrating an example of an image of the sample in which the glossiness has been decreased according to a clockwise manipulation by the user. In the sample image illustrated in FIG. 21, glossiness has been lost and each color patch is darker compared to the state before manipulation (the sample image illustrated in FIG. 19). In FIG. 21, illustrations and arrows indicate that further rotating the sample clockwise causes the glossiness to decrease, and conversely, rotating the sample counterclockwise causes the glossiness to increase. Note that in the sample images illustrated in FIGS. 19 to 21, the appropriate amount of manipulation for increasing or decreasing glossiness is not reflected in the length and size of the arrows, but the length of the arrows may also represent the amount of rotation to the angle at which glossiness is at a maximum. This assist display enables the user to anticipate the appropriate amount of manipulation before performing the manipulation.

Otherwise, in the assist display, the rotation angle to reach the angle at which glossiness is at a maximum may also be displayed as a number on the screen. For example, an indication such as “32° until glossiness is maximized.” may be adopted. This assist display enables the user to know the definite amount of manipulation that is appropriate before performing the manipulation. Also, in the screen examples illustrated in FIGS. 19 to 21, assistance regarding the direction of increasing or decreasing glossiness is provided only for the rotation direction in the horizontal plane (the plane defined by the x and y axes in FIG. 9 and the like), but assistance may also be provided for an angle inclined to the horizontal plane or the like. Use of the assistance function according to the present exemplary embodiment makes it possible to check the glossiness of the sample easily, even in cases in which the user manually adjusts the positional relationship of the sample and the like.

### Fourth Exemplary Embodiment

When the user manually adjusts the positional relationship of the sample and the like, in some cases, the direction of manipulation on the manipulation screen may be converted into rotation about a specific axis of the sample or the like. For example, in some cases, manipulation in the top-bottom direction of the manipulation screen may be converted into rotation about the long axis (x axis) of the sample on the manipulation screen and manipulation in the left-right direction of the manipulation screen may be converted into rotation about the short axis (y axis) of the sample on the manipulation screen. In these cases, if the relationship between the X and Y axes defining the manipulation screen is consistent with the relationship between the x and y axes of the sample displayed on the manipulation screen, user manipulation will be consistent with the rotation direction of the sample image.

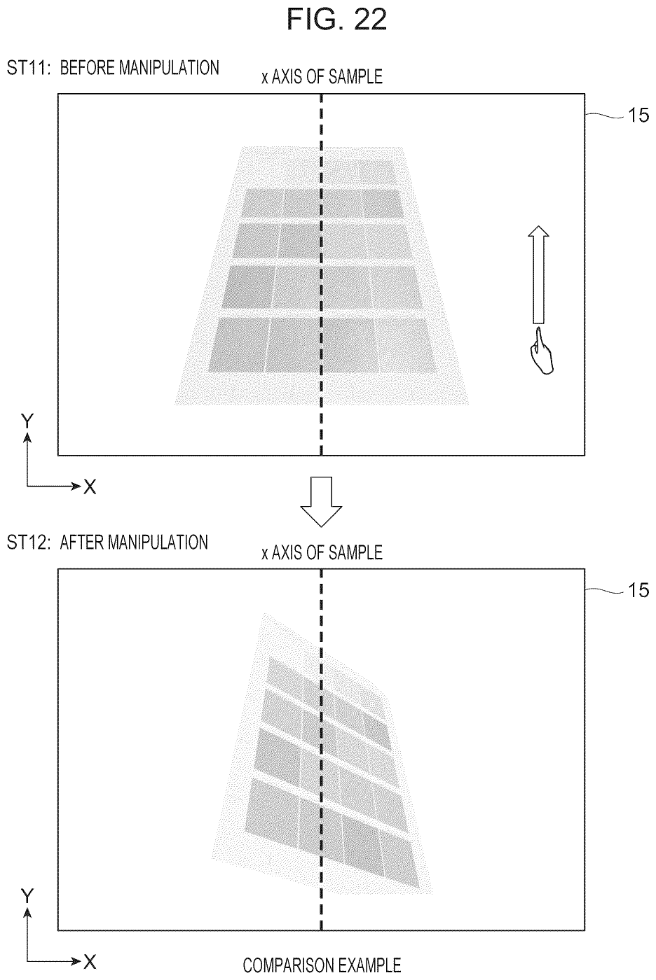

However, in some cases, the relationship between the X and Y axes defining the manipulation screen may not be consistent with the relationship between the x and y axes of the sample displayed on the manipulation screen. FIG. 22 is a diagram for explaining a change in the orientation of the sample image in a case in which the X axis defining the manipulation screen and the x axis of the sample displayed on the manipulation screen are orthogonal. The change of orientation illustrated in FIG. 22 is a change that is not assumed in the present exemplary embodiment, and therefore the illustration is titled “Comparison Example”.

For the manipulation screen in FIG. 22, the horizontal direction is the X axis and the vertical direction is the Y axis. Additionally, manipulation in the top-bottom direction (that is, the Y-axis direction) of the manipulation screen is associated with rotation about the long axis (x axis) of the sample. Specifically, manipulation toward the top of the manipulation screen is associated with clockwise rotation about the x axis of the sample, whereas manipulation toward the bottom of the manipulation screen is associated with counterclockwise rotation about the x axis of the sample. The user predicts manipulation of the sample image by using the manipulation screen as a reference. Consequently, if the user wants to rotate the sample image about the X axis, the user inputs a manipulation in the top-bottom direction with respect to the manipulation screen.

However, in the case of FIG. 22, there is a fixed relationship between the direction of manipulation on the manipulation screen and the rotation axis of the sample image. Therefore, if the user inputs a manipulation in the top-bottom direction of the manipulation screen, the sample image on the manipulation screen will rotate about the long axis, namely the x axis. In the case of FIG. 22, the long axis of the sample image in the state S11 before the manipulation is parallel to the Y axis of the manipulation screen. For this reason, the operation in the top-bottom direction by the user is converted into rotation about the Y axis of the manipulation screen. As a result, the orientation of the sample image in the state S12 after manipulation is largely different from the direction of rotation that the user expected.

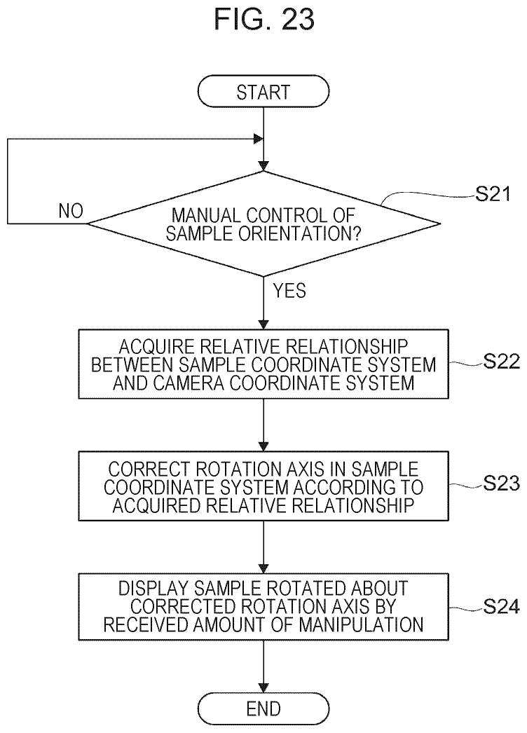

Accordingly, the present exemplary embodiment describes a function for correcting the rotation axis of the sample to be associated with a manipulation received on the manipulation screen according to the relative relationship between the coordinate system of the manipulation screen and the coordinate system of the sample on the manipulation screen. FIG. 23 is a flowchart for explaining a process of correcting the rotation axis with the processor 31 (see FIG. 2). First, the processor 31 determines whether the manual control of the sample orientation is enabled (step 21).

If manual control of the sample orientation is not enabled, a negative result is obtained in step 21. This example may correspond to the case in which automatic control of glossiness is designated. In this case, the processor 31 repeats the determination in step 21. If manual control of the sample orientation is enabled, a positive result is obtained in step 21. In this case, the processor 31 acquires the relative relationship between the coordinate system of the sample and the coordinate system of the camera (step 22). Here, the coordinate system of the camera is the same as the coordinate system of the manipulation screen. This is because the sample image captured by the camera is displayed on the manipulation screen.

Next, the processor 31 corrects the rotation axis in the coordinate system of the sample according to the acquired relative relationship (step 23). For example, if the angle θ obtained between the X axis in the coordinate system of the camera and the x axis in the coordinate system of the sample is 0°, rotational manipulation about the X axis in the coordinate system of the camera is associated with rotation about the x axis of the sample.

If the angle θ obtained between the X axis in the coordinate system of the camera and the x axis in the coordinate system of the sample is +45°, rotational manipulation about the X axis in the coordinate system of the camera is associated with rotation about a corrected rotation axis obtained by rotating the x axis of the sample −45°. If the angle θ obtained between the X axis in the coordinate system of the camera and the x axis in the coordinate system of the sample is +90°, rotational manipulation about the X axis in the coordinate system of the camera is associated with rotation about a corrected rotation axis obtained by rotating the x axis of the sample −90°.

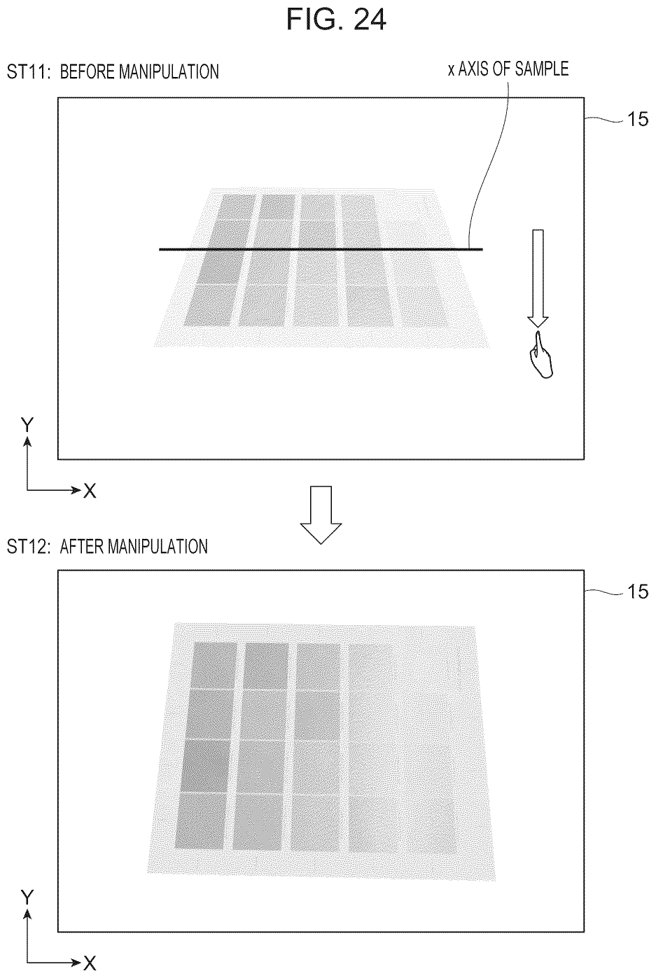

Thereafter, the processor 31 displays the sample rotated about the corrected rotation axis by the received amount of manipulation (step 24). FIG. 24 is a diagram for explaining a change in the orientation of a sample image in a case in which the X axis defining the manipulation screen and the x axis of the sample displayed on the manipulation screen are parallel. In the case of FIG. 24, the x axis of the sample in the state S11 before manipulation is parallel to the X axis of the manipulation screen. In other words, the x axis of the sample is parallel to the X axis in the camera coordinate system.

In the case of FIG. 24, too, manipulation toward the top of the manipulation screen is associated with clockwise rotation about the x axis of the sample, whereas manipulation toward the bottom of the manipulation screen is associated with counterclockwise rotation about the x axis of the sample. In the state ST12 after manipulation, the sample image is represented for the case of receiving manipulation in the top-bottom direction on the manipulation screen. The sample in the state ST12 after manipulation has been changed to a more upright orientation compared to the state before manipulation. As a result, glossiness is apparent on the right side on the sample.

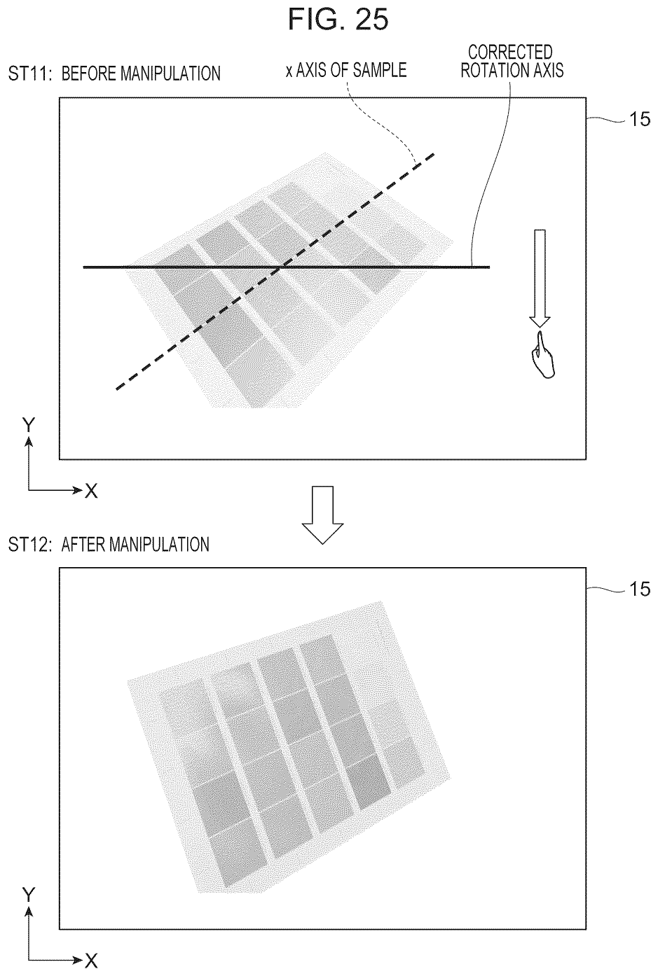

FIG. 25 is a diagram for explaining a change in the orientation of a sample image in a case in which the X axis defining the manipulation screen and the x axis of the sample displayed on the manipulation screen are approximately 45° apart. In the case of FIG. 25, the x axis of the sample in the state S11 before manipulation is inclined with respect to the X axis of the manipulation screen. However, due to the correction in step 23 (see FIG. 23), the corrected rotation axis is parallel to the X axis of the manipulation screen. Therefore, the sample in the state ST12 after manipulation has been changed to a more upright orientation compared to the state before manipulation. In the case of FIG. 25, glossiness is apparent in the upper-left portion of the sample.

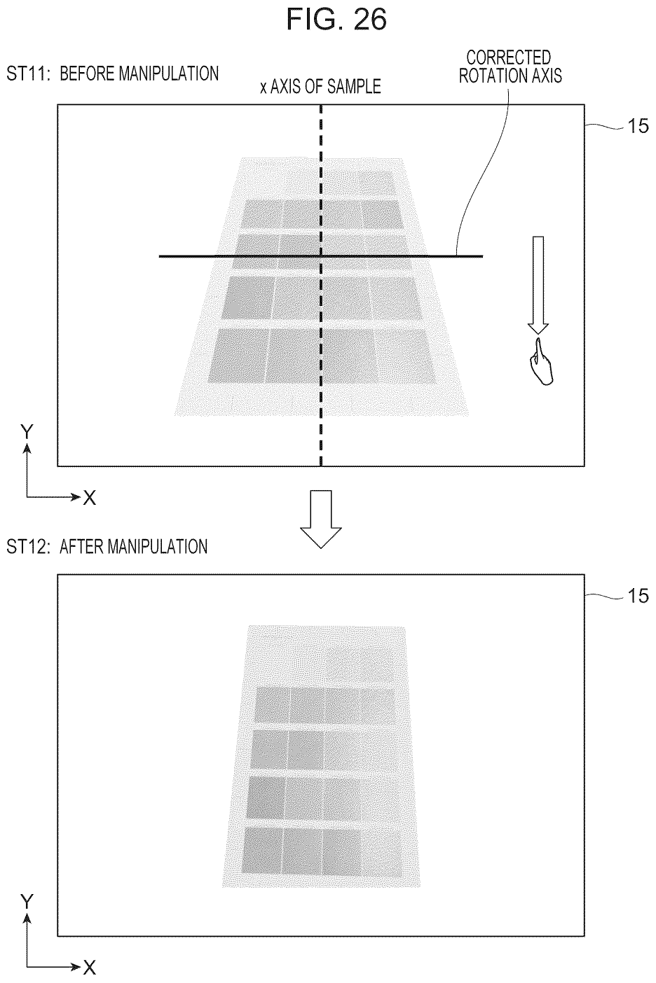

FIG. 26 is a diagram for explaining a change in the orientation of a sample image in a case in which the X axis defining the manipulation screen and the x axis of the sample displayed on the manipulation screen are approximately 90° apart. In the case of FIG. 26, the x axis of the sample in the state Si 1 before manipulation is orthogonal to the X axis of the manipulation screen. In other words, the x axis of the sample is parallel to the Y axis of the manipulation screen. However, due to the correction in step 23 (see FIG. 23), the corrected rotation axis is parallel to the X axis of the manipulation screen. Therefore, the sample in the state ST12 after manipulation has been changed to a more upright orientation compared to the state before manipulation. Unlike the comparison example illustrated in FIG. 22, this orientation is also in accord with the manipulation that the user intends. Note that in the case of FIG. 26, glossiness is apparent all over the surface of the sample. In this way, if the assistance function according to the present exemplary embodiment is used, even if the user manually adjusts the positional relationship of the sample and the like, control of the orientation according to the user-intended manipulation is reflected in the sample image.

### Fifth Exemplary Embodiment

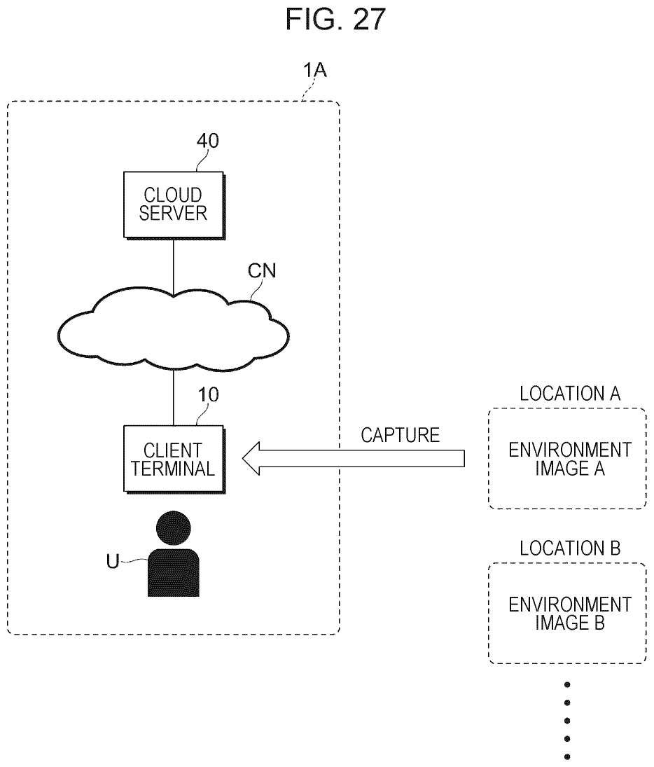

FIG. 27 is a diagram illustrating an exemplary configuration of an information processing system 1A used in the fifth exemplary embodiment. In FIG. 27, portions that correspond to FIG. 1 are denoted with the same signs. The information processing system 1A illustrated in FIG. 27 includes the client terminal 10 and a cloud server 40. The above are communicably connected through a cloud network CN. The cloud server 40 referred to herein is also an example of an information processing apparatus. The hardware configuration of the cloud server 40 is the same as the hardware configuration illustrated in FIG. 2.

The information processing system 1A illustrated in FIG. 27 differs from the printing system 1 illustrated in FIG. 1 in that the formation of an image by the image forming apparatus 20 (see FIG. 1) is not presumed. In the present exemplary embodiment, it is possible to make the appearance of the sample image approach the appearance at the observation site through execution of a program in the cloud server 40. Note that in the case of FIG. 27, a cloud server 40 specializing in texture simulation is prepared, but similar processing operations may also be executed by the client terminal 10 alone.

### Other Exemplary Embodiments

(1) The foregoing describes exemplary embodiments of the present disclosure, but the technical scope of the present disclosure is not limited to the scope described in the foregoing exemplary embodiments. It is clear from the claims that a variety of modifications or alterations to the foregoing exemplary embodiments are also included in the technical scope of the present disclosure.

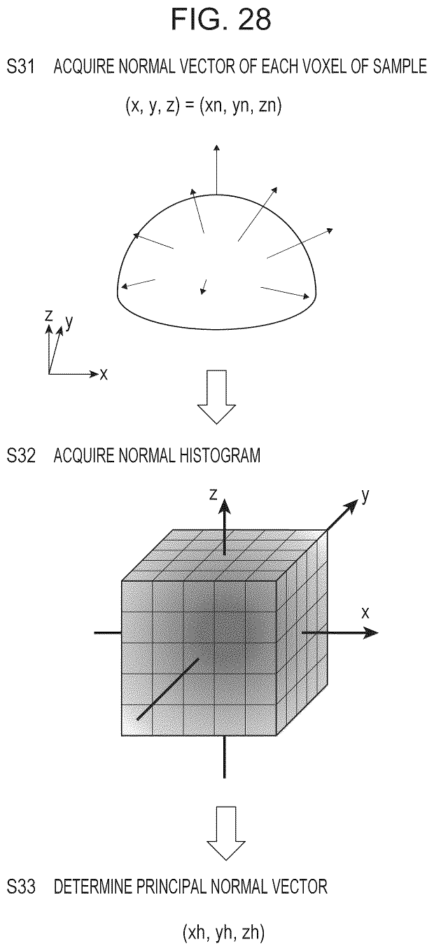

(2) In the exemplary embodiments above, the sample is assumed to be printed material, that is, an object with a two-dimensional shape, but the sample may also be an object with a three-dimensional shape. In the case of simulating a three-dimensional object, information (that is, sample information) defining the shape and surface of the three-dimensional object is used to calculate the appearance of the object at the observation site. FIG. 28 is a diagram illustrating an example of processing operations to acquire a principal normal vector of a three-dimensional shape.

First, the processor 31 (see FIG. 2) acquires the normal vector N at each voxel of the sample (step 31). Next, the processor 31 acquires a normal histogram, which is a distribution of the acquired normal vectors (step 32). The processor 31 obtains the normal occurring most frequently in the normal histogram as the “principal normal vector” (step 33). In the case of the present exemplary embodiment, the principal normal vector of the sample is (x, y, z)=(xh, yh, zh).

(3) In the exemplary embodiments above, the term “processor” refers to hardware in a broad sense. Examples of the processor include general processors (e.g., CPU: Central Processing Unit), dedicated processors (e.g., GPU: Graphics Processing Unit, ASIC: Application Specific Integrated Circuit, FPGA: Field Programmable Gate Array, and programmable logic device). In the exemplary embodiments above, the term “processor” is broad enough to encompass one processor or plural processors in collaboration which are located physically apart from each other but may work cooperatively. The order of operations of the processor is not limited to one described in the exemplary embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing apparatus comprising a processor configured to: acquire a position of principal illumination from a spherical image; acquire a direction of a principal normal of an object to be observed; acquire an observation condition of the object; and identify, on a basis of the position of principal illumination, the direction of the principal normal, and the observation condition, a positional relationship with which a light component reflected specularly by a plane corresponding to the principal normal.

(((2)))

The information processing apparatus according to (((1))), wherein the processor is configured to control, if an observation condition of the object is designated, an orientation of the object within the spherical image to satisfy the positional relationship.

(((3)))

The information processing apparatus according to (((1))), wherein the processor is configured to control, if an orientation of the object within the spherical image is designated, an observation condition of the object to satisfy the positional relationship.

(((4)))

The information processing apparatus according to (((1))), wherein the processor is configured to control, if a composition of an image with which to observe the object is designated, a rotation of the spherical image such that a position of the principal illumination is moved to a position to satisfy the positional relationship.

(((5)))

The information processing apparatus according to (((1))), wherein the processor is configured to detect, if a composition of an image with which to observe the object is designated, an orientation of the object and the observation condition to satisfy the composition within the spherical image and the positional relationship.

(((6)))

The information processing apparatus according to any one of (((1))) to (((5))), wherein the processor is configured to acquire the position of principal illumination through analysis of a distribution of luminance in the spherical image using a position of the object as a reference.

(((7)))

The information processing apparatus according to any one of (((1))) to (((5))), wherein the processor is configured to acquire the position of principal illumination through analysis of a distribution of illuminance in the spherical image using a position of the object as a reference.

(((8)))

The information processing apparatus according to any one of (((1))) to (((7))), wherein the processor is configured to generate an image of the object on a basis of the positional relationship, and display the generated image on a display of a terminal operated by a user.

(((9)))

The information processing apparatus according to (((8))), wherein the processor is configured to display, on the display, an operable element that accepts an increase or decrease in an intensity of the light component to be observed in the image of the object.

(((10)))

The information processing apparatus according to (((9))), wherein the processor is configured to cause, if an adjustment to the intensity is accepted through the operable element, the display to display an image according to the accepted intensity.

(((11)))

The information processing apparatus according to (((9))) or (((10))), wherein the processor is configured to cause a direction of change in an orientation of the image on the display to be aligned with a direction of operation of the operable element.

(((12)))

The information processing apparatus according to any one of (((1))) to (((11))), wherein the object has a three-dimensional shape.

(((13)))

A program causing a computer to achieve functions comprising: acquiring a position of principal illumination from a spherical image; acquiring a direction of a principal normal of an object to be observed; acquiring an observation condition of the object; and identifying, on a basis of the position of principal illumination, the direction of the principal normal, and the observation condition, a positional relationship with which a light component reflected specularly by a plane corresponding to the principal normal.

What is claimed is:

1. An information processing apparatus comprising:
a processor configured to:
acquire a position of principal illumination from a spherical image;
acquire a direction of a principal normal of an object to be observed;
acquire an observation condition of the object; and
identify, on a basis of the position of principal illumination, the direction of the principal normal, and the observation condition, a positional relationship with which a light component reflected specularly by a plane corresponding to the principal normal.

2. The information processing apparatus according to claim 1, wherein the processor is configured to control, if an observation condition of the object is designated, an orientation of the object within the spherical image to satisfy the positional relationship.

3. The information processing apparatus according to claim 1, wherein the processor is configured to control, if an orientation of the object within the spherical image is designated, an observation condition of the object to satisfy the positional relationship.

4. The information processing apparatus according to claim 1, wherein the processor is configured to control, if a composition of an image with which to observe the object is designated, a rotation of the spherical image such that a position of the principal illumination is moved to a position to satisfy the positional relationship.

5. The information processing apparatus according to claim 1, wherein the processor is configured to detect, if a composition of an image with which to observe the object is designated, an orientation of the object and the observation condition to satisfy the composition within the spherical image and the positional relationship.

6. The information processing apparatus according to claim 1, wherein the processor is configured to acquire the position of principal illumination through analysis of a distribution of luminance in the spherical image using a position of the object as a reference.

7. The information processing apparatus according to claim 1, wherein the processor is configured to acquire the position of principal illumination through analysis of a distribution of illuminance in the spherical image using a position of the object as a reference.

8. The information processing apparatus according to claim 1, wherein the processor is configured to generate an image of the object on a basis of the positional relationship, and display the generated image on a display of a terminal operated by a user.

9. The information processing apparatus according to claim 8, wherein the processor is configured to display, on the display, an operable element that accepts an increase or decrease in an intensity of the light component to be observed in the image of the object.

10. The information processing apparatus according to claim 9, wherein the processor is configured to cause, if an adjustment to the intensity is accepted through the operable element, the display to display an image according to the accepted intensity.

11. The information processing apparatus according to claim 9, wherein the processor is configured to cause a direction of change in an orientation of the image on the display to be aligned with a direction of operation of the operable element.

12. The information processing apparatus according to claim 1, wherein the object has a three-dimensional shape.

13. An information processing method comprising:
acquiring a position of principal illumination from a spherical image;
acquiring a direction of a principal normal of an object to be observed;
acquiring an observation condition of the object; and
identifying, on a basis of the position of principal illumination, the direction of the principal normal, and the observation condition, a positional relationship with which a light component reflected specularly by a plane corresponding to the principal normal.

14. A non-transitory computer readable medium storing a program causing a computer to execute a process comprising:
acquiring a position of principal illumination from a spherical image;
acquiring a direction of a principal normal of an object to be observed;
acquiring an observation condition of the object; and
identifying, on a basis of the position of principal illumination, the direction of the principal normal, and the observation condition, a positional relationship with which a light component reflected specularly by a plane corresponding to the principal normal.
